(19) United States
(12) Patent Application Publication
(10) Pub. No.: US 2020/0209643 A1
(43) Pub. Date: Jul. 2, 2020

(54) DIFFRACTIVE ILLUMINATION DEVICE WITH INCREASED DIFFRACTION ANGLE

(71) Applicant: INSTITUT MINES TELECOM, PALAISEAU (FR)

(72) Inventors: Kevin HEGGARTY, Lanrivoare (FR); Julien LE MEUR, Plouzane (FR)

(21) Appl. No.: 16/634,098

(22) PCT Filed: Jul. 23, 2018
(86) PCT No.: PCT/EP2018/069942

§ 371 Date: Jan. 24, 2020

(30) Foreign Application Priority Data
Jul. 24, 2017 (FR) 1757023

(51) Int. Cl. G02B 27/42; G02B 27/20; G02B 5/18; G02B 27/48

(52) U.S. Cl. CPC G02B 27/425; G02B 27/20; G02B 27/48; G02B 5/1842; G02B 27/4255

(57) ABSTRACT

The present invention relates to an optical device for generating a diffracted image on a support (S), said device comprising a diffractive optical element (5) arranged to diffract an optical beam, in order to generate a diffraction image. The device further comprises an optical power mirror (7.1; 7.2; 7.3; 7.4; 7.5), the mirror being placed with respect to the diffractive optical element so as to project the diffraction figure towards the support to obtain a magnified version of the diffracted image.

The present invention relates to the field of diffractive optics, and relates more specifically to an optical illumination device based on diffractive optical elements adapted to generate a magnified diffracted image on a projection support.

The invention applies more particularly to the illumination of an object or a scene by a diffracted image, such as a structured luminous pattern in the context of the acquisition and recognition of three-dimensional objects, for example for biometric identification with a mobile phone.

The invention can also be used to generate luminous marking at ground level projected by an aircraft, such as a helicopter, a plane or a drone, to indicate and secure a landing area for the aircraft.

In the field of telecommunications, the invention can also be used to distribute a set of laser beams in optical fibre matrices of optical communication networks.

Moreover, the invention can also be useful in the preparation of laser beams adapted to the machining, cutting or welding of mechanical parts.

In the following description, the term DOE (Diffractive Optical Element) is used to describe any type of synthetic optical component the purpose of which is to prepare the wavefront of an incident optical radiation, so as to transform it into the desired wavefront. This transformation is based on an optical diffraction phenomenon following known diffraction laws, such as the Fraunhofer or Fresnel equations.

In practice, a diffractive optical element is generally made of a substrate, such as a glass slide, on which or wherein are profiled microstructures or nanostructures configured to diffract an incident light beam, so as to generate the desired luminous pattern constituting a diffracted image. This luminous pattern can consist, for example, of a matrix of luminous points forming a luminous grid.

In a known manner, the dimensions of the diffracted image or, in an equivalent manner, the maximum diffraction angle αₘ of the diffractive optical element depends on the size and in particular on the depth of the micro or nanostructures engraved at the surface of said element. In general, a reduction of the size of these structures induces an increase of the diffraction angle αₘ, which translates into a magnification of the desired luminous pattern at the output of the diffractive optical element.

In numerous applications, high diffraction angles are much sought after, in particular to produce extended luminous patterns in optical systems with a small size. Thus, the compactness criterion is critical, in particular for the design of biometric or morphology recognition systems intended to be implemented in handheld devices, such as mobile phones, in order to identify the users thereof.

It is a recognised fact that the design and the manufacturing of these small micro or nanostructures (or in an equivalent manner with high diffraction angles) is problematic, in particular for the following reasons. On the one hand, the theory and the simplest models of scalar diffraction are no longer valid for optical diffractive elements comprising microstructures of which the size is close to the wavelength of the light used (i.e. of approximately 1 μm in the visible spectrum). In this case, vector diffraction models that are very demanding in terms of computing power are required. This has a major disadvantage of increasing the cost and time required to design diffractive optical elements with an increased diffraction angle.

On the other hand, for structure sizes of less than 1 μm, conventional manufacturing technologies, such as direct laser writing or photolithography in the near-ultraviolet spectrum, and optical metrology means such as optical microscopes become insufficient. Thus, more expensive manufacturing and metrology means, such as scanning electron microscopes and e-beam direct-write means become necessary to increase the angle of diffraction of the diffractive optical elements.

Empirically, considering wavelengths in the visible spectrum and using diffractive optical elements based on scalar diffraction models and optical manufacturing techniques limited to structure sizes of approximately 1 μm, the half-angle of maximum diffraction αₘ that can be achieved is approximately equal to 15° with respect to the optical axis of the diffractive optical element, i.e. a total diffraction angle is approximately equal to 30°.

By definition, the half-angle of maximum diffraction is the angle formed by the intersection of the optical axis of the diffractive optical element and a diffracted radiation having maximum divergence with respect to this optical axis.

In projection systems based on diffractive optical elements, it is a known fact that a part of the light that is not diffracted by the diffractive optical element, called zero-order diffracted light, is transmitted through the diffractive optical element, such that this light finds itself in the diffracted image.

Based on the nature of the light used, and on the wavelength thereof, the zero-order diffracted light is potentially dangerous to the human eye. This is in particular the case for systems relying on laser-type light sources, for example for biometric face recognition applications, for which the diffracted image (e.g. a luminous grid) is projected on the face of an individual. There is therefore a need to reduce, or eliminate the zero-order diffracted light at the output of such systems, so as to increase eye safety for users.

The solutions proposed to date to reduce or eliminate the zero-order diffracted light rely mainly on the use of optical filters or any other filtering component, which increases the complexity and weight of current systems. However, these solutions are not adapted to the miniaturisation or increased compactness needs that systems are now faced with, in particular for biometric applications intended to be deployed in mobile phones or on-board terminals.

One of the aims of the present invention is to solve at least one of the abovementioned disadvantages.

Therefore, the invention proposes an optical device in order to obtain a diffracted image on a support, said device comprising a diffractive optical element arranged to diffract an optical beam, so as to generate a diffraction image, said device further comprising an optical power mirror, the mirror being placed with respect to the diffractive optical element so as to project the diffraction image to the support in order to obtain a magnified version of said diffracted image on the support.

In the following description, the term “optical power” describes the degree to which the mirror converges or diverges light.

Thus, the diffractive illumination device according to the invention is able to provide a magnified diffracted image compatible with the use of conventionally-sized diffractive optical elements.

Contrary to the conventional approach that aims at reducing the size of the micro/nanostructures to increase the maximum diffraction angle of the diffractive optical elements, the principle of the present invention consists of adding, at the output of the diffractive optical element, an optical power mirror. In the scope of the invention, the overall effect of the mirror is to diverge the light beam at the output of the device.

Therefore, the diffraction angle actually seen at the output of the device is increased with respect to the intrinsic diffraction angle of the diffractive optical element.

The addition of such a mirror advantageously reaches a half-angle of effective diffraction largely greater than 15° with respect to the optical axis of the diffractive optical element, i.e. a total angle of 30° on either side of the optical axis. The invention therefore increases the size of diffracted images, while relaxing the constraint relating to the size of the micro/nanostructures of the diffractive optical elements, thus enabling the use of less costly and faster manufacturing technologies.

In practice, the present invention enables the use of conventional diffractive optical elements, designed from simple scalar diffraction models, and built to dimension parameters of the microstructures that are greater than 1 μm.

The optical power mirror generally serves to widen the light beam at the output of the optical device, which is the same as increasing the actual diffraction angle of the optical device. Thus, the diffracted image projected on the support is magnified.

The use of such a mirror is particularly advantageous, in particular with respect to the use of one or more refractive lenses, and in particular for the following reasons.

Firstly, the mirror makes it possible to fold the optical path of the device by reflection on the surface thereof. This feature of the invention renders all of the device more compact, with respect to an assembly operating by transmission, wherein the beam is routed through one or more lenses to achieve magnification of the beam at the output of the lenses.

Secondly, a mirror has the advantage of operating in an identical manner, regardless of the wavelength reflected by the mirror, as the focal length of a mirror does not depend on the wavelength of use. Consequently, the magnification achieved by the mirror is independent from the wavelength of the incident optical beam, contrary to the case of a refractive lens for which the refractive index is a function of the wavelength of the incident light.

Thus, the invention can be advantageously used for the diffraction of colour images, for example in an optical system with multiple wavelengths of the RGB type (Red, Green, Blue) comprising three laser sources with different wavelengths, or a polychromatic laser source.

Thirdly, the use of such a mirror can be particularly advantageous in terms of eliminating the unwanted zero-order diffracted light (i.e. non-diffracted), while ensuring a simpler and more compact architecture than a lens-based solution. Indeed, after reflection on a mirror, the passage of this light is blocked by the presence of the light source.

The blocking of the zero-order light is particularly advantageous in terms of eye safety, in particular when the diffracted image is projected on the face of an individual, specifically in the scope of a face recognition application.

According to one feature of the invention, the device further comprises a light source and a converging lens arranged to focus a beam of light emitted by said light source in an intermediate image plane, the diffractive optical element being arranged to diffract the beam of light.

Thus, the device makes it possible to generate a diffracted image.

According to one embodiment of the invention, the mirror is concave, i.e. with a hollow and curved reflective surface seen from the converging lens.

According to another embodiment of the invention, the mirror is convex, i.e. with a domed reflective surface seen from the converging lens.

The convex mirror has the same advantages as the concave mirror with respect to the use of lenses. The convex nature of the mirror further reduces the size of the device compared to a concave shape.

According to another feature of the invention, the light source, the diffractive optical element and the converging lens are all aligned along a common optical axis.

According to another feature of the invention, the mirror is placed, with respect to the converging lens, such that said intermediate image plane is located between the mirror and the focal plane of the mirror.

According to another feature of the invention, the mirror comprises a non-reflective zone, for example transparent or absorbent, said zone being located at the intersection of the common optical axis and the mirror.

Because of this absorbent or non-reflective zone, zero-order diffracted radiation emitted by the diffractive optical element is not reflected by the mirror, and is instead absorbed or transmitted through the mirror along the optical axis at the level of the central zone of the mirror.

Thus, the desired diffracted beam comprises only diffracted components with an order greater than zero, which makes it easier to ensure the eye safety of users (necessary, for example, when projecting a diffracted image on the face of an individual for the purpose of analysis by a facial recognition algorithm).

According to another feature of the invention, the diffractive optical element is movable along the common optical axis.

The movement of the diffractive optical element along the common optical axis has the effect of adjusting the size or scope of the beam of light at the output of the mirror, thus enabling the adjustment of the actual diffraction angle of the device. Thus, it is possible to increase or reduce the size of the image projected on the support at a fixed distance from the light source.

According to another feature of the invention, the mirror is movable along the common optical axis.

This degree of mobility advantageously makes it possible to adjust the actual diffraction angle value of the device according to the invention.

According to another feature of the invention, the mirror has an optical axis that is separate from the common optical axis and forms a non-zero angle with the common optical axis.

The orientation of the mirror enables advantageously to project the desired diffracted image outside of the common optical axis, i.e. in a direction different from the direction of the incident beam, while avoiding the presence of zero-order diffracted light in the projected image.

According to another feature of the invention, the device comprises means to orient the optical axis of the mirror, according to a degree of rotational freedom around at least one axis perpendicular to said common optical axis.

The movable character of the mirror is particularly advantageous to scan a desired diffracted image.

According to another feature of the invention, the mirror and the diffractive optical element are provided on the same component, the diffractive optical element and the mirror being formed on two opposite faces of said component.

The use of a mirror enables and facilitates the production of a highly compact, single-unit, diffracting optical device, wherein the diffractive optical element and the mirror are jointly made on a same “moulded” element, obtained by injection or nano-printing.

According to another feature of the invention, the mirror has a curvature with a spherical shape.

The spherical mirror has the effect of efficiently amplifying the actual diffraction angle of the device, thus enabling projection of magnified real images by using diffractive optical elements having intrinsically lower diffraction angles. Thus, by relaxing the constraint on the size of diffracting structures, it is possible to use diffractive optical elements that are easier to design and manufacture.

According to another feature of the invention, the mirror has a curvature with an aspheric shape.

According to an alternative of the invention, the curvature has a parabolic shape. In other words, the mirror is parabolic.

An aspheric mirror, such as a parabolic mirror, advantageously makes it possible to correct aberrations and distortions due to a projection of the image, and in particular due to projection outside of the optical axis, while optimising the compactness of the device.

According to another feature of the invention, the device further comprises means to apply vibrations to the mirror.

By submitting the mirror to reduced mechanical vibrations, it is advantageously possible to limit speckle-type noise in the form of shimmers seen in the diffracted image projected by the mirror, thus improving the quality of the projected image.

According to another feature of the invention, the mirror is deformable.

The deformation of the mirror can modify the focal length of the mirror and consequently the magnification of the diffracted image projected on the support. Thus, the actual diffraction angle can be adapted without moving the mirror or by limiting the movement of the diffractive optical element, so as to ensure improved compactness. In contrast, for solutions based on the use of lenses as a means of optical divergence, a movement of the lenses is generally required to change the size of the projected image.

According to another feature of the invention, the light source is a semiconductor laser.

There are highly compact semiconductor laser modules available on the market making it possible to reduce the size of the device according to the invention.

The present invention also aims for an assembly comprising the device according to the invention and a support on which it is intended that a diffracted image generated and/or obtained by said device is to be projected.

Other features, advantages and details of the present invention will be made clearer upon reading the following description of several embodiment examples of the invention, provided by way of example and not limited thereto, said description being made with reference to the appended drawings, wherein:

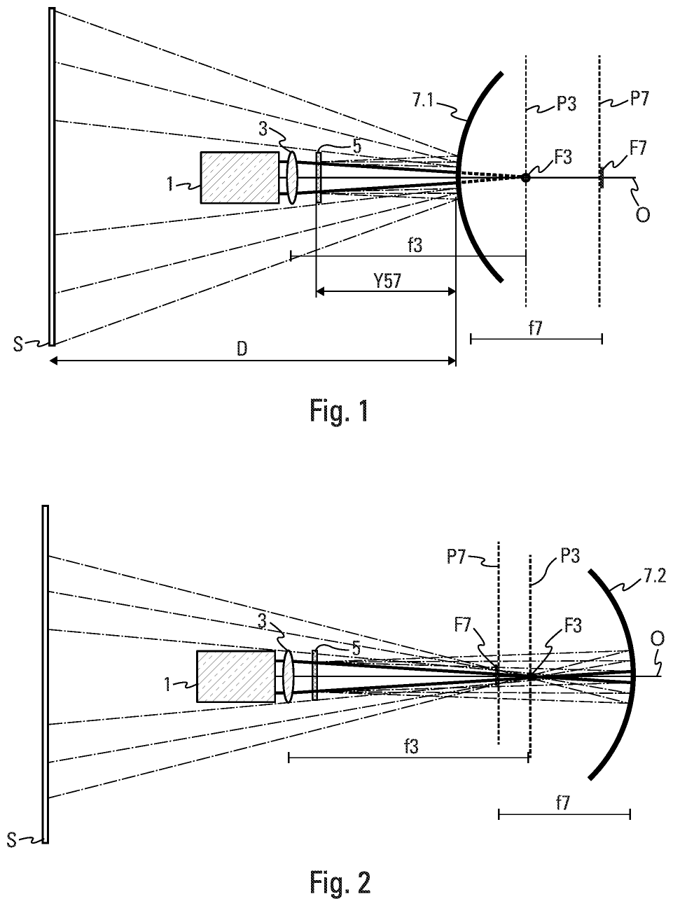

FIG. 1 is a schematic view of the architecture of the device according to the invention and according to a first embodiment,

FIG. 2 is a schematic view of the architecture of the device according to the invention and according to a second embodiment,

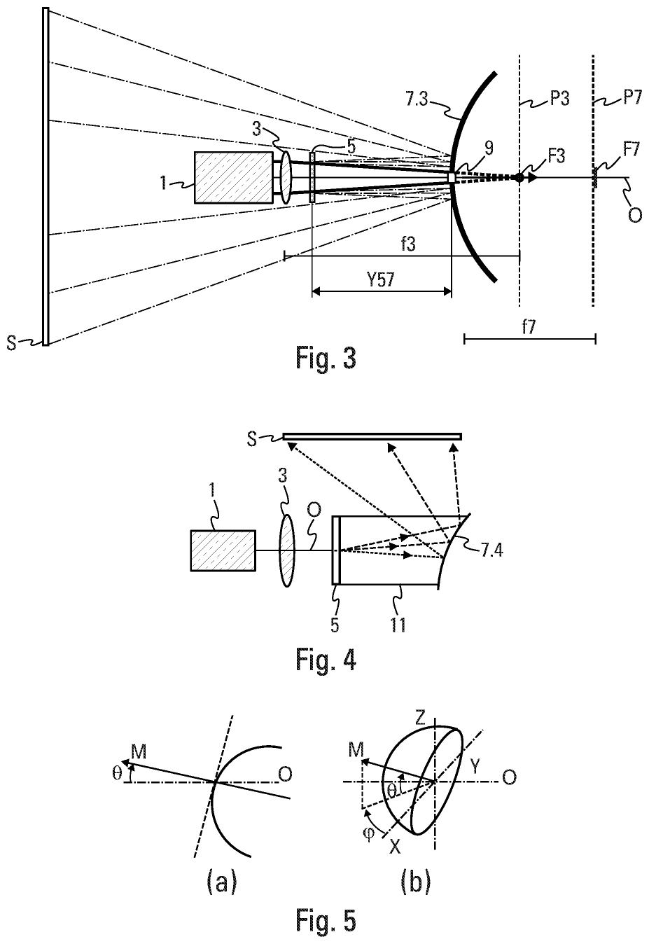

FIG. 3 shows an alternative version of the second embodiment,

FIG. 4 is a schematic view of the architecture of the device according to the invention and according to a third embodiment, and

FIG. 5 is a schematic view of the inclination of the mirror.

As is shown in FIGS. 1 to 4, the device according to the invention comprises a light source 1, a converging lens 3 arranged at the output of the source, a diffractive optical element 5 arranged at the output of the lens and a mirror 7.1; 7.2; 7.3; 7.4 arranged at the output of the diffractive optical element 5.

In the examples described below, it is considered that the light source 1 consists of a laser module able to emit coherent and monochromatic radiation (i.e. a laser beam).

Of course, the nature and emitting properties of the light source 1 can be adapted to suit the desired application. Thus, the source 1 can be a monochromatic or polychromatic coherent light source. For example, for the projection of diffracted colour images, the light source 1 can be polychromatic comprising three laser sources adapted to emit respectively laser radiation at different wavelengths. Alternatively, the polychromatic light source can consist of a single laser module with an adjustable wavelength. Such a module can be controlled to emit sequentially laser radiation at different wavelengths.

According to a preferred feature of the invention, the light source 1 consists of a semiconductor laser module. It must be noted that there are currently highly compact semiconductor laser modules on the market, typically of around several mm³ or several cm³, advantageously making it possible to make the device according to the invention very compact. The compactness of the device is particularly sought after in the context of biometric applications intended to be implemented in mobile phones.

By way of example, the diffractive optical element 5 is obtained, conventionally, by direct writing of a laser beam in a layer of photosensitive material deposited on a substrate. The writing is achieved according to a model obtained based on the desired image that is to be projected onto the support, by application of an inverse calculation and quantification algorithm. The resulting DOE has microstructures with a critical dimension of approximately 1 μm.

Generally, the light source 1 is arranged so as to illuminate the DOE 5 through the converging lens 3. The source 1, the DOE 5 and the lens 3 are aligned along a common optical axis O.

In the case of the light source 1 consisting of a semiconductor laser module, the converging lens 3 is particularly useful in terms of correcting the divergence of the laser beam coming from this module 1, because in practice, compact semiconductor laser modules emit a diverging laser beam.

Thus, the converging lens 3 located between the light source 1 and the DOE 5 forms an image of the light source through the DOE in an image plane P3 of the converging lens 3. In the following description, this image plane P3 is described as intermediate plane P3. This image, called intermediate image, corresponds to the diffraction image generated by the DOE 5. As shown in FIGS. 1, 2 and 3, this intermediate plane P3 is located between the mirror 7.1; 7.2; 7.3 and a focal plane of the mirror P7, at a distance f3 from the converging lens 3 that corresponds to the conjugated image distance of the lens 3.

In practice, this distance f3 is typically several mm or cm and greater than the focal length of the lens. For example, for compact systems, such as mobile phones of the smartphone type, this distance f3 can be of less than 1 cm. In a known manner, the conjugated image distance relates to the distance separating the lens from the light source through conventional conjugation relations commonly used in geometrical optics.

In the specific embodiments, such as shown in FIGS. 1, 2 and 3, the mirror 7.1; 7.2; 7.3 is arranged so as to be aligned with the assembly formed by the light source 1, the converging lens 3 and the diffractive optical element 5, along the common optical axis O. In these scenarios, the optical device according to the invention is optically centred on the optical axis O, that is common to each of the components thereof (i.e. light source 1, converging lens 3, DOE 5).

A first embodiment of the invention is now described with reference to FIG. 1, according to which the mirror is a convex mirror 7.1.

The convex shape of the mirror is defined such that the reflective surface thereof has a curvature turned towards the surface of the diffractive optical element 5 as seen from the converging lens 3. In other words, the reflective surface of the convex mirror 7.1 is domed in the direction of light propagation, between the source 1 and the mirror 7.1.

In this embodiment, the convex mirror 7.1 is arranged along the common optical axis O, between the converging lens 3 and the intermediate plane P3, i.e. upstream from this plane with respect to the direction of light propagation between the light source 1 and the mirror 7.1.

A virtual intermediate image generated by the diffractive optical element 5 is formed by the converging lens 3 in the intermediate plane P3 located downstream from the mirror with respect to the direction of light propagation between the light source 1 and the mirror.

This intermediate image corresponds to the image diffracted by the diffractive optical element 5. Thus, the convex mirror 7.1 transforms the intermediate image contained in the intermediate plane P3 into a magnified real image intended to be projected on a support S.

Thus, the beam reflected by the convex mirror 7.1 and projected on the support S is advantageously magnified with respect to the incident beam, as shown in FIG. 1.

For example, such a support can be the face of an individual who is to be identified by facial recognition, or the surface of a landing area of an aircraft, or a wall used as projection screen.

Advantageously, the real image projected on the support S contains no zero-order diffracted light. Indeed, the light that has not been diffracted by the diffractive optical element 5 has been reflected in the direction of the light source 1 along the common optical axis O but does not reach the support S because the laser module, being in the alignment of the common optical axis O, creates an obstacle to the propagation of this radiation in the vicinity of the common optical axis O.

Thus, the zero-order diffracted radiation is advantageously filtered by the presence of the laser module 1, without requiring additional filtering components, thereby simplifying the global architecture of the device.

A second embodiment of the invention is now described with reference to FIG. 2. This second embodiment differs from the embodiment described above with reference to FIG. 1 in that the mirror is a concave mirror 7.2 instead of a convex mirror.

In the following description, concave is used to describe a mirror of which the reflective surface has a hollow curvature seen from the converging lens 3. In other words, the reflective surface of the concave mirror 7.2 is hollow in the direction of light propagation, between the light source 1 and the mirror.

In this embodiment, the concave mirror 7.2 has the feature of being arranged along the optical axis O, downstream from the intermediate plane P3 with respect to the direction of light propagation between the source 1 and the mirror.

Because of the concave shape thereof, the intermediate plane P3 where the intermediate image is formed is located upstream from the concave mirror 7.2 with respect to the direction of light propagation, between the light source 1 and the mirror. As described above, the distance f3 separating the converging lens 3 from this intermediate plane P3 is equal to the conjugated image distance of the converging lens 3.

As for the first embodiment, the concave mirror 7.2 generates a real magnified real image on the support S, such that the device according to the invention has an actual diffraction angle that is increased with respect to the maximum diffraction angle intrinsic to the diffractive optical element 5.

As for the first embodiment, the zero-order radiation diffracted by the diffractive optical element 5 and then reflected by the mirror is physically eliminated by the presence of the laser module 1 in the vicinity of the common optical axis O.

According to an alternative embodiment of the first embodiment, the convex mirror 7.3 comprises a non-reflective zone 9, as shown in FIG. 3, to prevent zero-order diffracted light from being projected on the support S.

This zone, called central zone, is located at the level of an intersection point of the mirror surface and the common optical axis O. The central zone 9 is preferably centred on this intersection point.

The non-reflective zone prevents zero-order diffracted radiation emitted by the diffractive optical element 5 from being reflected by the mirror, and is instead absorbed by this zone or transmitted through this zone along the optical axis O.

Thus, the non-reflective zone can consist of an absorbent material adapted to absorb all or some of the zero-order diffracted radiation.

For example, this zone can consist of a material that is transparent to incident light, such that the incident beam is integrally transmitted through this zone, i.e. without optical losses. Alternatively, this zone can consist of an opening adapted to let light pass through the mirror.

For example, the opening can be filled with an optically-transparent material adapted to transmit all the light, or a part thereof.

The integral transmission of the zero-order diffracted light at the output of the mirror is particularly interesting in characterising, in real time, the emission properties of the laser module 1.

The same alternative embodiments and the example embodiment provided above also apply to the second embodiment of FIG. 2. In this case (not shown), the concave mirror 7.2 comprises the same non-reflective central zone 9, such as described previously with reference to FIG. 3. It has the same effects and advantages as those described above.

Generally, this central zone 9 can be provided on any type of optical power mirror included in the scope of the present invention.

According to a feature of the invention, the diffractive optical element 5 is movable along the common optical axis O with respect to the mirror 7.1; 7.2; 7.3. This feature applies in particular to the embodiments described with reference to FIGS. 1, 2 and 3 and more broadly to any embodiment or alternative embodiment where the diffractive optical element 5 is not formed as a single-block with the mirror, as is described below with reference to FIG. 4.

By adjusting the distance Y57 between the diffractive optical element 5 and the optical power mirror, it is possible to change the magnification factor of the real image projected by the mirror. In an equivalent manner, this movement makes it possible to change the actual diffraction angle of the device. Thus, the size of the real image projected on the screen S can be dynamically adjusted, i.e. increased or reduced, depending on the intended use.

It must be noted that the actual diffraction angle can be adjusted without changing the position of the projection support S. Thus, it is possible to achieve a variable magnification of the real image projected on the support by maintaining a fixed projection distance D between the surface of the mirror and the support S.

Thus, by moving the diffractive optical element 5 closer to or away from the mirror, in a continuous (or progressive) manner along the optical axis O, it is possible to provide an illumination device able to project a real diffracted image, with a size that can be increased or reduced in a continuous manner, with the possibility of projecting at a fixed distance of this device.

This movement can be achieved by means of a platform (not shown) slidably mounted on a rail along the optical axis and on which is fixed the diffractive optical element 5. The actuation of the platform can be achieved manually or automatically by means of a motor controlled by a control module according to the requirements of the desired application.

A third embodiment of the invention is now described with reference to FIG. 4. This embodiment differs from the second embodiment in that the real image is projected outside of the common optical axis O.

Therefore, the mirror 7.4 is oriented so that its specific optical axis M (or in an equivalent manner, its axis of symmetry) forms a non-zero angle with the common optical axis O as shown in FIG. 5. In other words, the optical axis of the mirror M is different from the common optical axis O, contrary to the embodiments described with reference to FIGS. 1 to 3.

FIG. 5B shows, more generally and in three dimensions, the orientation of the mirror according to at most two degrees of rotational freedom defined by the angles θ and φ respectively with respect to the axes X and Z of an orthonormal reference X, Y, Z, these two axes being perpendicular to the common optical axis O. The value of the angles θ and φ can be adjusted based on the desired application. For example, an angle of 90° is particularly useful to simplify the inclusion of this type of device in the thickness of a smartphone or a tablet.

According to another aspect of the invention, the device comprises means to orient the mirror according to a degree of rotational freedom θ, φ around at least one axis X; Z perpendicular to the common optical axis O.

According to a first example embodiment, these means are based on MEMS (MicroElectroMechanical Systems) enabling electrically control of the orientation of a micro plate on which the mirror is fixed.

According to a second example embodiment, these means are based on a scanning galvo mirror systems.

According to a third embodiment, the zero-order diffracted radiation is still eliminated by the laser module 1, as described for the other embodiments described above.

According to an alternative version of this third embodiment, the inclined convex mirror 7.4 is formed of a single block with the diffractive optical element 5, as shown in FIG. 4.

The mirror makes the optical device highly compact, which would not be easy with the use of lenses as a means of optical divergence.

For example, the diffractive optical element 5 and the mirror 7.4 are jointly made on the same element that can be moulded, obtained by injection or by lithography, by nano-printing. Microstructures can be etched on a first face of a component made of glass, so as to form the diffractive optical element 5. A thin metallic layer can be deposited on a second face of the component, the second face being arranged opposite the first face. The second surface can be formed by moulding. Thus, a single-unit component comprising the diffractive optical element and the mirror on two of the opposite faces thereof can be easily achieved with conventional manufacturing techniques.

In the example of FIG. 4, a convex mirror has been shown. However, other alternative versions can be considered by using any other type of optical power mirror, such as the ones that have already been described (concave, spherical, parabolic) as alternative embodiments, based on the needs of the desired application.

It must be noted that the use of convex or concave mirrors to produce the desired magnification is advantageous to provide great flexibility in the choice of component and mountings to block the zero-order diffracted light.

According to an aspect of the invention, the surface of the mirror is spherical in shape. This feature is applied regardless of the concave or convex nature of the mirror, and can generally apply to any one of the embodiments, as already described with reference to FIGS. 1 to 4.

The spherical nature efficiently amplifies the actual diffraction angle, thus projecting real images with an increased size, while using diffractive optical elements that feature intrinsically diffraction angles limited by constraints relating to design and/or manufacturing means of the micro/nanostructures of these elements.

The spherical shape of the mirror is particularly well adapted to reach actual diffraction angles with a value greater than 30° (total angle value, as opposed to the value of the half-angle), with a size of the microstructures of approximately 1 μm.

Thus, the use of the spherically-shaped mirror advantageously makes it possible to project diffracted images with an increased size by using diffractive optical elements that are inexpensive and easy to design and manufacture.

In the embodiments such as those shown in FIGS. 1 to 4, the mirror 7.1; 7.2; 7.3; 7.4 was selected with a spherical form.

However, according to another aspect of the invention, the mirror can be replaced, in any one of these embodiments, and even in other non-described embodiments, with a parabolic mirror, or more generally with an aspheric mirror. In a similar manner as for a spherical mirror, the parabolic or aspheric mirror can have a convex or concave shape, as described above.

The use of a parabolic mirror is particularly well adapted to correct aberrations and/or optical distortions due to a projection of the real image outside of the optical axis O, while optimising the compactness of the device.

Generally, the adjustment of the actual diffraction angle by modification of the distance Y57 separating the diffractive optical element 5 from the mirror as described in the first embodiment with reference to FIG. 1, remains valid for each of the embodiments described above, except in the case where the diffractive optical element 5 cannot be moved when it is integrated as a single unit with the mirror on one same component.

According to the embodiments described with reference to FIGS. 1, 2, 4, by positioning correctly the light source 1, the diffractive optical element and the mirror in the alignment of the optical axis O, the zero-order diffracted radiation reflected at the surface of the mirror at the level of the optical axis O is physically eliminated by the laser module casing 1.

As described above, this advantageously eliminates zero-order luminous points from the real image projected on the support S, the power of which can be relatively high and potentially dangerous to the human eye.

Thus, the device according to the invention eliminates the zero-order diffracted components in the real image, thus reducing potential ocular risks, without requiring additional filtering components. In this manner, the architecture of the device according to the invention is greatly simplified and has a relatively reduced size, in particular with respect to lens-based solutions.

Generally speaking, the device according to any one of the embodiments described above can further comprise means to apply vibrations to the mirror (not shown).

By submitting the mirror to reduced mechanical vibrations, it is advantageously possible to limit speckle-type noise in the form of shimmers seen in the diffracted image projected by the mirror, thus improving the quality of the projected image. These mechanical vibrations can be produced, for example, by means of a MEMS device or by a galvo mirror system.

In the embodiments described above, the diffractive optical element 5 used is a Fourier diffractive optical element. In this case, the intermediate image plane P3 corresponds to the image plane of the converging lens 3 located at the conjugated image distance f3 from the converging lens.

However, the invention also applies in the case where the diffractive optical element is a Fresnel diffractive optical element, i.e. having an optical power that can be diverging or converging. In this case, the above description remains valid, with the difference that the intermediate image plane P3 such as shown in FIGS. 1 to 4 does not correspond to the image plane of the converging lens 3, but to an intermediate image plane that also depends on the optical power of the diffractive optical element. Thus, the intermediate image plane P3, wherein is formed the intermediate image generated by the Fresnel diffractive optical element, is located, with respect to the converging lens 3, at a distance greater or shorter (and not equal) than the conjugated image distance f3.

The use of a Fresnel diffractive optical element is particularly advantageous to defocus, with respect to the focal plane of the image generated by the Fresnel diffractive optical element, the zero-order diffracted light in the vicinity of the common optical axis and thus improves the optical safety of users compared with laser beams transmitted through the diffractive optical element.

Of course, the invention is not limited to the example embodiments described and provided above, from which other embodiments can be developed, without departing from the scope of the invention.

1. An optical device for obtaining a diffracted image on a support, said device comprising:
a diffractive optical element arranged to diffract an optical beam, so as to generate a diffraction image, and
an optical power mirror placed with respect to the diffractive optical element so as to project the diffraction image towards the support in order to obtain a magnified version of said diffracted image on the support.

2. The device according to claim 1, further comprising a light source and a converging lens arranged to focus a beam of light emitted by said light source, in an intermediate image plane, said diffractive optical element being arranged to diffract said beam of light.

3. The device according to claim 2, wherein the mirror is concave with a hollow and curved reflective surface seen from the converging lens.

4. The device according to claim 2, wherein the mirror is convex with a hollow and curved reflective surface seen from the converging lens.

5. The device according to claim 2, wherein the light source, the diffractive optical element and the converging lens are all aligned along a common optical axis.

6. The device according to claim 2, wherein said mirror is placed, with respect to the converging lens, such that said intermediate image plane is located between the mirror and the focal plane of the mirror.

7. The device according to claim 5, wherein the mirror comprises a non-reflective zone located at the intersection of the common optical axis and the mirror.

8. The device according to claim 5, wherein the diffractive optical element is movable along the common optical axis.

9. The device according to claim 5, wherein the mirror is movable along the common optical axis.

10. The device according to claim 5, wherein the mirror has an optical axis that is separate from the common optical axis and forms a non-zero angle with said common optical axis.

11. The device according to claim 10, further comprising means to orient the optical axis of the mirror, according to a degree of rotational freedom around at least one axis perpendicular to said common optical axis.

12. The device according to claim 1, wherein the mirror and the diffractive optical element are provided on one same component, the diffractive optical element and the mirror being formed on two opposite faces of said component.

13. The device according to claim 1, wherein the mirror has a curvature with a spherical shape.

14. The device according to claim 1, wherein the mirror has a curvature with an aspheric shape.

15. The device according to claim 14, wherein the curvature is parabolic in shape.

16. The device according to claim 1, wherein the device further comprises means to apply vibrations to the mirror.

17. The device according to claim 1, wherein the mirror is deformable.

18. The device according to claim 2, wherein the light source is a semiconductor laser.

19. An assembly comprising:
a support, and
an optical device for obtaining a diffracted image on a support, said device comprising:
a diffractive optical element arranged to diffract an optical beam, so as to generate a diffraction image, and
an optical power mirror placed with respect to the diffractive optical element so as to project the diffraction image towards the support in order to obtain a magnified version of said diffracted image on the support.
